(19) United States
(12) Patent Application Publication
(10) Pub. No.: US 2025/0160464 A1
(43) Pub. Date: May 22, 2025

(54) HELMET APPARATUS WITH CAMERAS FOR VIEWING A USERS ENVIRONMENT

(71) Applicant: Raymond Carter, Phoenix, AZ (US)

(72) Inventor: Raymond Carter, Phoenix, AZ (US)

(21) Appl. No.: 18/512,186

(22) Filed: Nov. 17, 2023

(51) Int. Cl. A42B 3/04; A42B 3/22; A42B 3/28; A42B 3/32; G01C 21/36; G06T 3/00; H04N 7/18; H04N 23/57; H04N 23/80; H04N 23/90

(52) U.S. Cl. CPC A42B 3/0426; A42B 3/225; A42B 3/226; A42B 3/283; A42B 3/32; G01C 21/3667; G06T 3/16; H04N 7/181; H04N 23/57; H04N 23/80; H04N 23/90

(57) ABSTRACT

A helmet apparatus for displaying a surrounding environment to a user includes a shell with cameras mounted to the shell. The cameras view respectively forwardly, rearwardly, and laterally from the shell, and a display is provided which shows images and video captured by the cameras on a visor also mounted to the shell.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to helmet and more particularly pertains to a new helmet for displaying a surrounding environment to a user.

### (2) Description of Related Art Including Information Disclosed Under 37 CFR 1.97 and 1.98

The prior art relates to helmets with cameras for viewing a user's surrounding environment. However, the prior art fails to describe such an apparatus with cameras facing forwardly, rearwardly, and in opposite lateral directions from the helmet such that the user is able to obtain a 360-degree view of the environment. Such a device would be advantageous over the prior art by facilitating the user in viewing areas which the devices of the prior art fail to reveal to the user.

### BRIEF SUMMARY OF THE INVENTION

An embodiment of the disclosure meets the needs presented above by generally comprising a shell which defines an interior space in the shell, an opening to the interior space in a bottom of the shell, and an aperture extending through a front side of the shell to the interior space. A visor is coupled to the shell and is positionable to cover the aperture. The visor also comprises a transparent material. A processor is mounted in the shell, and a plurality of cameras and a display are operatively coupled to the processor. The cameras are mounted to the shell and face outwardly away from the shell. The cameras include a front camera which faces forwardly from the shell, a rear camera which faces rearwardly from the shell, and a pair of lateral cameras which face respective lateral directions away from the shell. The display is configured to show images on the visor, and the processor is programmed to cause the display to show video streams captured by one of the plurality of cameras.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front side perspective view of a helmet apparatus according to an embodiment of the disclosure.

FIG. 2 is a side view of an embodiment of the disclosure.

FIG. 3 is a front view of an embodiment of the disclosure.

FIG. 4 is a rear view of an embodiment of the disclosure.

FIG. 5 is an in-use view of an embodiment of the disclosure.

FIG. 6 is a front view of an alternative embodiment of the disclosure which uses a projector for a display.

### DETAILED DESCRIPTION OF THE INVENTION

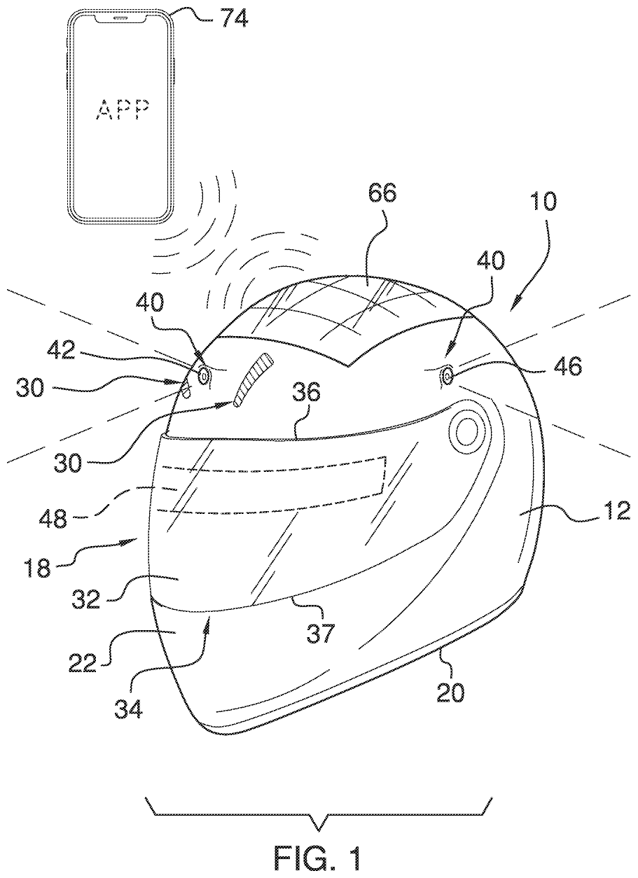

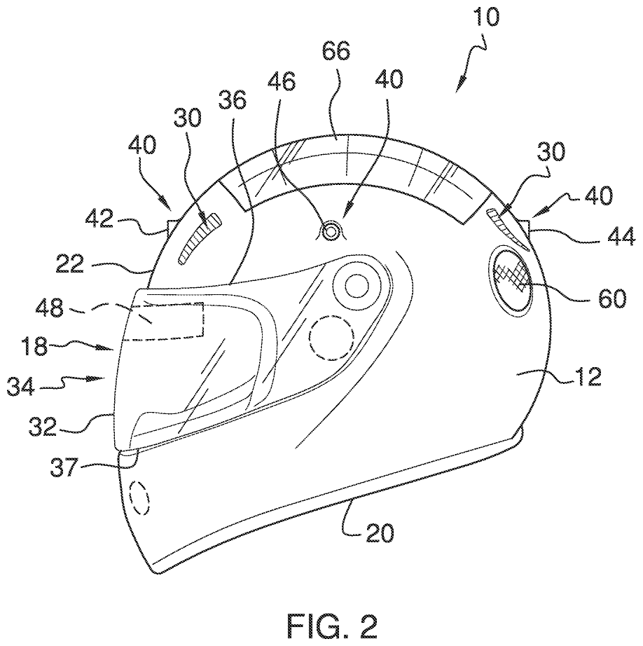

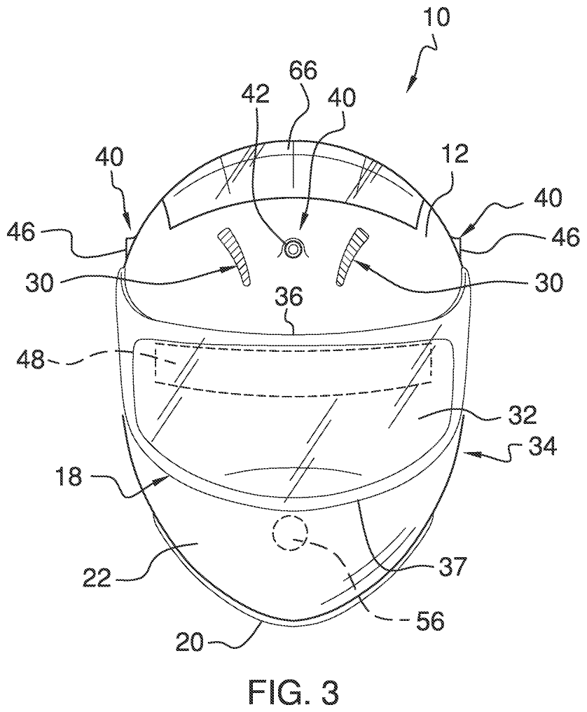

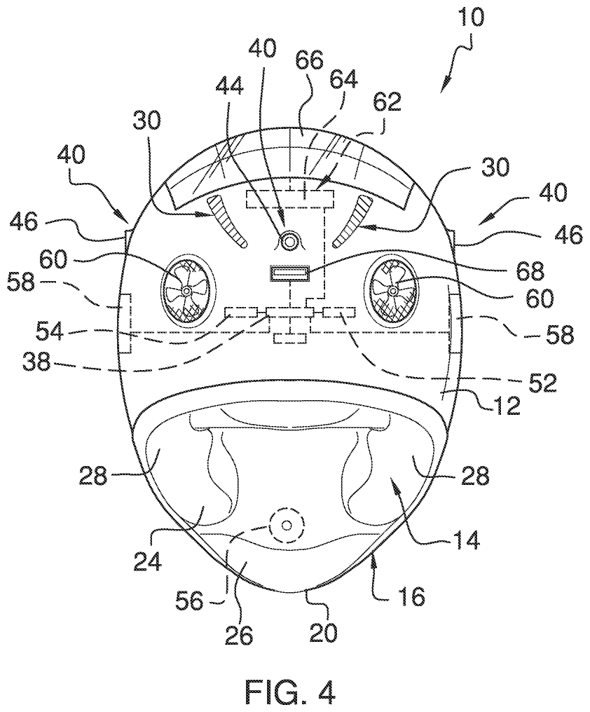

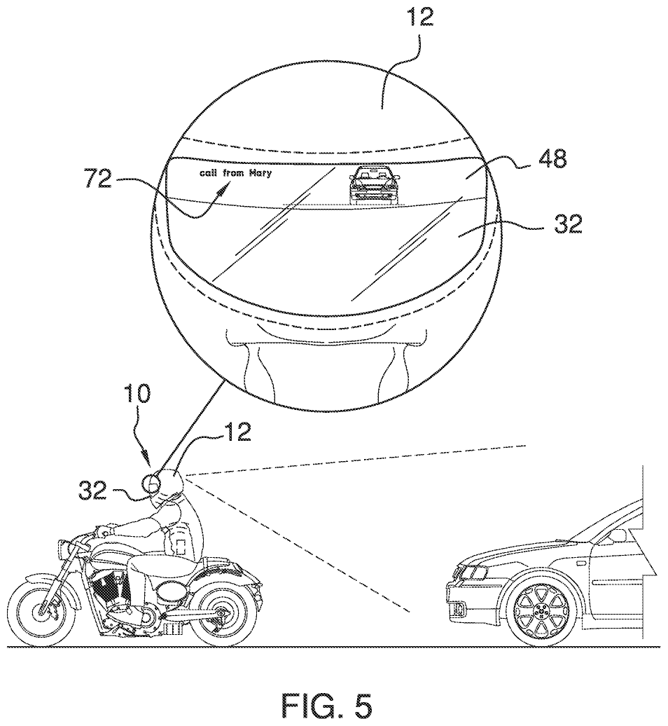

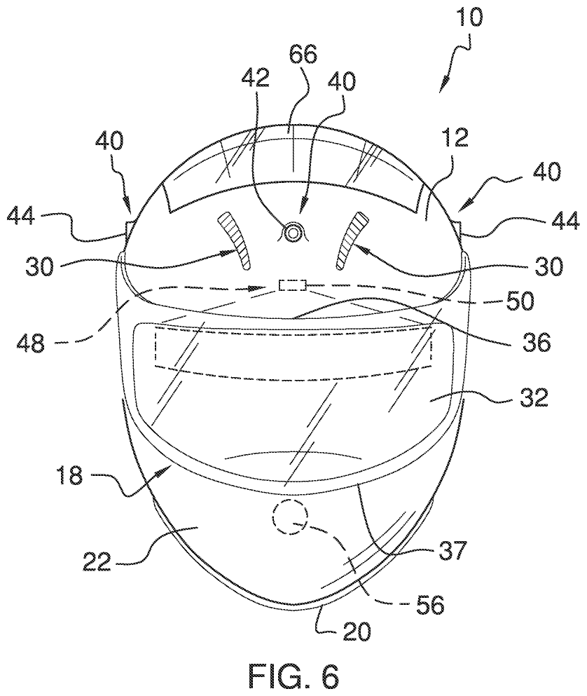

With reference now to the drawings, and in particular to FIGS. 1 through 6 thereof, a new helmet embodying the principles and concepts of an embodiment of the disclosure and generally designated by the reference numeral 10 will be described.

As best illustrated in FIGS. 1 through 6, the helmet apparatus 10 generally comprises a shell 12 which defines an interior space 14 in the shell 12. The shell 12 also defines an opening 16 to the interior space 14 in a bottom 20 of the shell 12, an aperture 18 extending through a front side 22 of the shell 12 to the interior space 14, and a plurality of vents 30 extending through the shell 12 to the interior space 14. A visor 32 is pivotally coupled to the shell 12 and is movable between a lowered position 34 and a raised position (not shown) and covers the aperture 18 when positioned in the lowered position 34. The visor 32 comprises a transparent material which is polarized to limit ultraviolet radiation being emitted through the visor 32.

A processor 38 is mounted in the shell 12 and has a memory. A plurality of cameras 40 is mounted to the shell 12, each of which is operatively coupled to the processor 38. Each camera 40 faces outwardly away from the shell 12. The plurality of cameras 40 includes a front camera 42 which faces forwardly from the shell 12, a rear camera 44 which faces rearwardly from the shell 12, and a pair of lateral cameras 46 which face respective lateral directions away from the shell 12. The processor 38 is programmed to store video from the plurality of cameras 40 on the memory and to generate composite images from all cameras 40 of the plurality of cameras 40. The composite images show a 350-degree view away from the shell 12 and may be still images or may be components of video streams or video recordings.

A display 48 is configured to show images on the visor 32 and is operatively coupled to the processor 38. The display 48 is mounted to the visor 32 and is positioned closer to a top edge 36 of the visor 32 than to a bottom edge 37 of the visor 32. In other embodiments, the display 48 may comprise a projector 50 mounted to the shell 12 and facing the visor 32. The processor 38 is programmed to cause the display 48 to show video streams captured by one of the plurality of cameras 40.

A global positioning system (GPS) module 52 is operatively coupled to the processor 38 and is programmed to receive navigation data from the GPS module 52 and cause the display 48 to show the navigation data. A transceiver 54 is operatively coupled to the processor 38 wherein the processor 38 is configured to wirelessly communicate with a remote electronic device 74. The processor 38 may receive operational commands from the remote electronic device 74 and send video and images captured by the cameras 40 to the remote electronic device 74. A microphone 56 and a pair of speakers 58 are mounted to an interior surface 24 of the shell 12 and are operatively coupled to the processor 38. The microphone 56 and the speakers 58 are usable to audibly communicate via a network connected to the processor 38. The processor 38 may, for example, be connected to a cellular network via the transceiver 54 or via the transceiver 54 and the remote electronic device 74. The microphone 56 is positioned on a front portion 26 of the interior surface 24 of the shell 12 between the aperture 18 and the bottom 20 of the shell 12. The speakers 58 are positioned on respective lateral portions 28 of the interior surface 24.

A pair of fans 60 is mounted in the shell 12 and is operatively coupled to the processor 38. The pair of fans 60 is configured to urge air between the interior space 14 and a surrounding environment. A power supply 62 is mounted in the shell 12 and is electrically coupled to the processor 38. The power supply 62 comprises a battery 64. A solar panel 66 is mounted atop the shell 12 and is electrically coupled to the battery 64. A charge port 68 is mounted to the shell 12 and is electrically coupled to the processor 38. The processor 38 is programmed to direct electricity from the charge port 68 to the battery 64.

In use, the helmet apparatus 10 is worn on a head of a user 70. The cameras 40 capture images or video of the surroundings of the user 70 and are shown to the user 70 via the display 48. Via an input, the user 70 may select one or more views captured by one or more of the cameras 40 for viewing via the display 48. For example, the user 70 may select a video stream captured by the rear camera 44 to be shown so that the user 70 may view the area behind the user 70. The processor 38 may also be programmed to show notifications 72 or other information via the display 48, such as an incoming call notification informing the user 70 of an incoming call.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A helmet apparatus comprising:
a shell defining an interior space in the shell, the shell defining an opening to the interior space in a bottom of the shell, the shell defining an aperture extending through a front side of the shell to the interior space;
a visor being coupled to the shell, the visor being positionable to cover the aperture, the visor comprising a transparent material;
a processor being mounted in the shell;
a plurality of cameras being mounted to the shell, each camera of the plurality of cameras being operatively coupled to the processor, each camera of the plurality of cameras facing outwardly away from the shell, the plurality of cameras including a front camera which faces forwardly from the shell, a rear camera which faces rearwardly from the shell, and a pair of lateral cameras which face respective lateral directions away from the shell; and
a display being configured to show images on the visor, the display being operatively coupled to the processor, the processor being programmed to cause the display to show video streams captured by one of the plurality of cameras; and
a fan being mounted in the shell, the fan being operatively coupled to the processor, the fan being configured to urge air between the interior space and a surrounding environment.

2. The apparatus of claim 1, wherein the shell defines a plurality of vents extending through the shell to the interior space.

3. The apparatus of claim 1, wherein the visor is movable between a lowered position and a raised position, the visor covering the aperture when positioned in the lowered position.

4. The apparatus of claim 1, wherein the visor is polarized.

5. The apparatus of claim 1, wherein the processor has a memory, the processor being programmed to store video from the plurality of cameras on the memory.

6. The apparatus of claim 1, wherein the display is mounted to the visor.

7. The apparatus of claim 1, wherein the display comprises a projector mounted to the shell and facing the visor.

8. The apparatus of claim 1, wherein the processor being programmed to generate composite images from all cameras of the plurality of cameras.

9. The apparatus of claim 1, further comprising a global positioning system (GPS) module being operatively coupled to the processor, the processor being programmed to receive navigation data from the GPS module and cause the display to show the navigation data.

10. The apparatus of claim 1, further comprising a transceiver being operatively coupled to the processor wherein the processor is configured to wirelessly communicate with a remote electronic device.

11. The apparatus of claim 1, further comprising a microphone being mounted to an interior surface of the shell, the microphone being positioned on a front portion of the interior surface between the aperture and the bottom of the shell, the microphone being operatively coupled to the processor.

12. The apparatus of claim 1, further comprising a speaker being mounted to an interior surface of the shell, the speaker being operatively coupled to the processor.

13. (canceled)

14. The apparatus of claim 1, further comprising a power supply being mounted in the shell, the power supply being electrically coupled to the processor.

15. The apparatus of claim 14, wherein the power supply comprises a battery.

16. The apparatus of claim 15, further comprising a solar panel being mounted atop the shell and being electrically coupled to the battery.

17. The apparatus of claim 15, further comprising a charge port being mounted to the shell and being electrically coupled to the processor, the processor being programmed to direct electricity from the charge port to the battery.

18. A helmet apparatus comprising:
a shell defining an interior space in the shell, the shell defining an opening to the interior space in a bottom of the shell, the shell defining an aperture extending through a front side of the shell to the interior space, the shell defining a plurality of vents extending through the shell to the interior space;
a visor being pivotally coupled to the shell, the visor being movable between a lowered position and a raised position, the visor covering the aperture when positioned in the lowered position, the visor comprising a transparent material, the transparent material of the visor being polarized;
a processor being mounted in the shell, the processor having a memory;
a plurality of cameras being mounted to the shell, each camera of the plurality of cameras being operatively coupled to the processor, each camera of the plurality of cameras facing outwardly away from the shell, the plurality of cameras including a front camera which faces forwardly from the shell, a rear camera which faces rearwardly from the shell, and a pair of lateral cameras which face respective lateral directions away from the shell, the processor being programmed to store video from the plurality of cameras on the memory, the processor being programmed to generate composite images from all cameras of the plurality of cameras;
a display being configured to show images on the visor, the display being operatively coupled to the processor, the display being mounted to the visor, the processor being programmed to cause the display to show video streams captured by one of the plurality of cameras, the display being positioned closer to a top edge of the visor than to a bottom edge of the visor;
a global positioning system (GPS) module being operatively coupled to the processor, the processor being programmed to receive navigation data from the GPS module and cause the display to show the navigation data;
a transceiver being operatively coupled to the processor wherein the processor is configured to wirelessly communicate with a remote electronic device;
a microphone being mounted to an interior surface of the shell, the microphone being positioned on a front portion of the interior surface between the aperture and the bottom of the shell, the microphone being operatively coupled to the processor;
a pair of speakers being mounted to an interior surface of the shell, the pair of speakers being positioned on respective lateral portions of the interior surface, the pair of speakers being operatively coupled to the processor;
a pair of fans being mounted in the shell, the pair of fans being operatively coupled to the processor, the pair of fans being configured to urge air between the interior space and a surrounding environment;
a power supply being mounted in the shell, the power supply being electrically coupled to the processor, the power supply comprising a battery;
a solar panel being mounted atop the shell and being electrically coupled to the battery; and
a charge port being mounted to the shell and being electrically coupled to the processor, the processor being programmed to direct electricity from the charge port to the battery.
